(19) United States
(12) Patent Application Publication
(10) Pub. No.: US 2006/0285329 A1
(43) Pub. Date: Dec. 21, 2006

(54) Integrated mullion and fluorescent lamp assembly for a commercial display refrigerator

(76) Inventors: Jerry Davey, Bradenton, FL (US); Mark Smith, Sarasota, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/153,137

(22) Filed: Jun. 15, 2005

(51) Int. Cl. F21V 23/02

(52) U.S. Cl. 362/260

(57) ABSTRACT

An integrated mullion and fluorescent lamp assembly for a display refrigerator comprising a mullion including an open-ended rear side, a longitudinal lens removably positioned over the open-ended rear side of the mullion and a lamp assembly positioned within the mullion, whereby heat from the lamp assembly heats the mullion.

### BACKGROUND OF THE INVENTION

1. Field of the Invention

This invention relates to commercial display refrigerators having glass doors for allowing viewing of merchandise contained within the refrigerator. More particularly, this invention relates to fluorescent lights that are employed within commercial display refrigerators for illuminating the merchandise contained therein.

2. Description of the Background Art

Presently, display refrigerators are commonly used in retail stores such as grocery and convenience stores for refrigerating merchandise such as beverages behind glass doors allowing the discriminating shopper to view the merchandise while shopping. Once the selection is made, the shopper may then open the glass door and remove the product from the refrigerator.

In order to maximize the shopper's viewing convenience while minimizing the tendency of the shopper to open the glass doors during the selection process, it has been desirable to fully illuminate the merchandise located within the refrigerated display. In this manner, the shopper will hopefully not stand with the display door open while making the selection. Rather, the shopper will mentally make the selection with the door closed and then open it to withdraw the selection. In this way, heat loss to the interior as well as potential fogging of the doors, is minimized. Hence, there has been a desire in the industry for illumination systems that fully illuminate the merchandise contained within the display refrigerator without obstructing the view thereof.

Presently, there exist various configurations of lighting systems for display refrigerators in which the fluorescent lamp fixture is positioned horizontally at the top or bottom of the merchandise shelving area. More recently, lighting systems have been positioned behind the end frames that support the respective glass doors and the mullions therebetween. By positioning the lighting system behind the end frames and mullions, they are generally concealed from view by the shopping consumer and therefore do not otherwise hinder the presentation of the merchandise to the consumer.

Moreover, various lens systems, covers and reflectors have been developed for directing the light rays from the fluorescent light in a direction toward the leading edge of the display shelves so that even the merchandise in the center of the shelf midway between the end frames and mullions is fully illuminated. Such lenses and reflectors have also been designed so as to minimize the reflection of light toward the glass doors themselves that would otherwise create a distracting glare on the glass doors (i.e., a “zebra” effect) and thereby not present as pleasing of a shopping environment for the consumer.

U.S. Pat. Nos. 5,016,146 and 5,471,372 the disclosures of which are hereby incorporated by reference herein, illustrate various types of mullion-mounted lighting systems for display refrigerators.

The various configurations of lenses and reflectors employed in mullion-mounted lighting systems have achieved wide acceptance in the industry. Unfortunately, the specific designs for such lighting systems vary from manufacturer to manufacturer. Moreover, the design of such lens covers typically requires that the lens be removed in its entirety in order to change the fluorescent lamp contained therein.

The fluorescent lamp lens assembly of commonly-owned U.S. Pat. No. 6,179,443, the disclosure of which is hereby incorporated by reference herein, presented a marked improvement to the aforementioned lens assemblies by affixing a universal lighting system to the rear inside of the end frames and mullions to illuminate the leading edge of the shelving while minimizing door glare. More particularly, as shown in FIGS. 1 and 2, the fluorescent lens assembly was generally tubular in configuration and included a length generally approximating the length of the fluorescent lamp. The fluorescent lamp was positioned into the lens assembly and held in concentric relation therein by means of a pair of end caps securing the fluorescent lamp within the tubular lens. Both of the caps allowed the terminal pins of the fluorescent lamp to extend outwardly allowing the pins to connect to the lamppost of a conventional fluorescent lamp fixture. One of the ends (e.g., the top end) was provided with a removable cap allowing a spent lamp to be removed therefrom and replaced with a new one. This allowed the convenient replacement of the fluorescent lamp as needed when they become spent (i.e., burned out).

The fluorescent lamp lens assembly of U.S. Pat. No. 6,179,443 has achieved significant commercial success. However, as noted above, it was employed by affixing it to the rear surface of the end frames and mullions of the doorway. By being affixed to the rear inside surface of the end frames and mullions, the heat produced by the lamps unavoidably escaped from the lamp assembly into the interior of the refrigerated space. The escaping heat served no purpose and merely increased the costs of maintaining the low temperature of the refrigerated space.

At the same time, heating strips are often employed inside the end frames and mullions to heat the same and reduce condensation that would otherwise occur due to the difference in temperatures between the refrigerated space and the ambient air. Thus, while heat is added to the end frames and mullions for a meaningful purpose, heat from the lamp assemblies is wasted. Typically, the wasted heat increases the energy bill on the order of $50 or more per door per year.

Accordingly, there presently exists a need in the commercial refrigerator art to use the unavoidable heat that escapes from a lamp assembly that illuminates the shelving to heat the end frame or mullion to which it is affixed and thereby eliminate or reduce the need for internal heating strips in the end frame or mullion.

Therefore, it is an object of this invention to provide an improvement which overcomes the aforementioned inadequacies of the prior art devices and provides an improvement which is a significant contribution to the advancement of the commercial display refrigerator art.

Another object of this invention is to provide an integrated mullion and fluorescent lamp assembly including a lamp assembly that is integrated into an end frame or mullion of a commercial display refrigerator such that the waste heat from the lamp is constructively used to heat the end frame or mullion to prevent condensation.

Another object of this invention is to provide an integrated mullion and fluorescent lamp assembly that results in a lamp being positioned closer to the end frame or mullion and therefore further away from the shelves such that lighting of the shelving is improved.

Another object of this invention is to provide an integrated mullion and fluorescent lamp assembly that may accommodate different-diameter fluorescent lamps.

Another object of this invention is to provide an integrated mullion and fluorescent lamp assembly with a protected lamp thereby minimizing lamp breakage.

Another object of this invention is to provide an integrated mullion and fluorescent lamp assembly having a lamp that will remain stable in cold temperatures.

Another object of this invention is to provide an integrated mullion and fluorescent lamp assembly that includes a lens that redirects the light to the product and out of the customer's eyes.

Another object of this invention is to provide an integrated mullion and fluorescent lamp assembly that largely constitutes a sealed assembly that provides insulation for the lamp, thus allowing greater light output, while also providing heat to heat the mullion and prevent condensation.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an integrated mullion and fluorescent lamp assembly for commercial display refrigerators including a lamp assembly that is integrated into an end frame or mullion of a commercial display refrigerator such that the otherwise waste heat from the lamp is constructively used to heat the end frame or mullion to prevent condensation. In lieu of the prior art separate lamp assemblies that are merely affixed to the surface of the end frame or mullion, the integrated mullion and fluorescent lamp lens assembly includes an end frame or mullion that has a longitudinal interior cavity extending from one end to the other. Fluorescent lamp posts are affixed at each end inside a longitudinal cavity to operatively receive a conventional fluorescent lamp. A longitudinal lens is snapped into the longitudinal edges of the end frame or mullion to cover the longitudinal cavity and define a closed cavity for fluorescent lamp. Notably, the lamp is positioned further away from the shelving such that lighting of the leading edge of the shelving is improved.

Importantly, front and sides of the end frame or mullion serve as heat sinks to absorb the heat discharged from the fluorescent lamp and to thereby heat the end frame or mullion. The heat absorbed by the end frame or mullion reduces the amount of condensation that might otherwise occur on the end frame or mullion due to the difference in temperatures. Indeed, the need for heat strips in the end frame or mullion may be eliminated, or at least the wattage of the heat strips contained therein may be reduced.

Ancillary benefits to the integrated mullion and fluorescent lamp assembly of the invention include the ability to accommodate different-diameter fluorescent lamps, the ability to protect the lamp to minimize lamp breakage, the ability to stabilize the temperature of the lamp in cold temperatures and the ability to redirect the light to the product on the shelves and out of the customer's eyes.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is an exploded view of the prior art fluorescent lamp assembly of U.S. Pat. No. 6,179,443 to be affixed to the inside surface of a mullion.

FIG. 2 is a cross-sectional view of the prior art fluorescent lamp assembly of U.S. Pat. No. 6,179,443 affixed to the rear surface of a mullion;

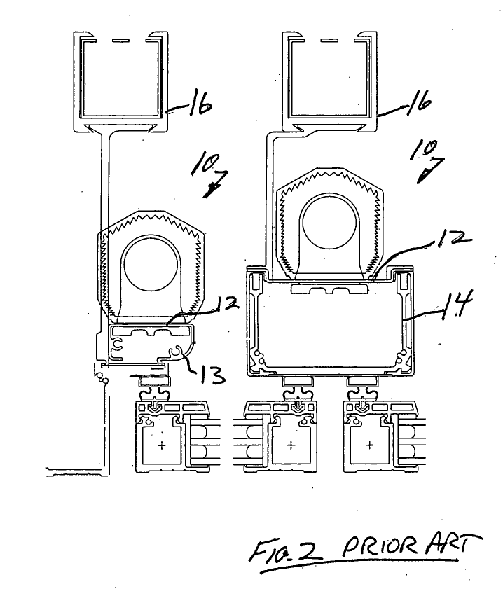

FIG. 3 is a cross-sectional view of the integrated mullion and fluorescent lamp assembly of the invention showing a lamp assembly that is integrated into an end frame and into a mullion of a commercial display refrigerator such that the otherwise waste heat from the lamp is constructively used to heat the end frame and mullion to prevent condensation; and

FIG. 4 is a cross-sectional view of FIG. 3 along lines 4-4 showing the reflector and frame plugs that create a chimney effect within the ceiling.

Similar reference characters refer to similar parts throughout the several views of the drawings.

### DETAILED DESCRIPTION OF THE PREFERRED EMBODIMENT

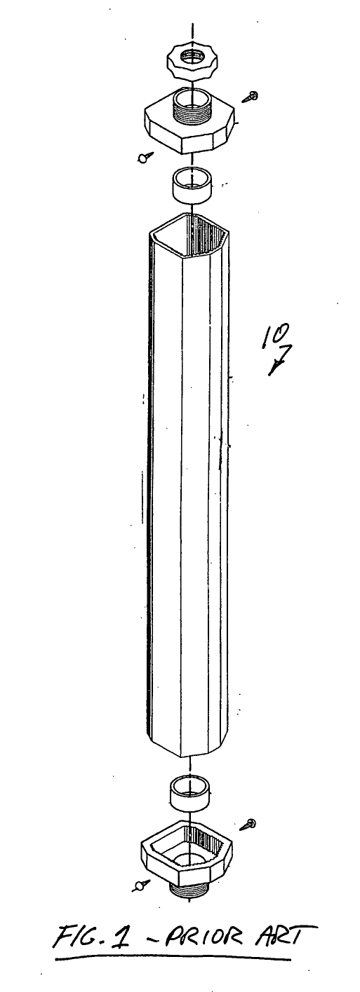

Referring to FIGS. 1 & 2, the prior art fluorescent assembly 10 taught by U.S. Pat. No. 6,179,443 was intended to be utilized by affixing it to the planar rear surface 12 of an end frame 13 or mullion 14 facing the shelving supports 16. Such a mullion-mounted fluorescent assembly 10 projected light onto the leading edge of the display shelves while minimizing glare on the glass refrigerator door 16. Unfortunately, however, due to the fact that the fluorescent assembly 10 was merely affixed to the rear planar surface 12 of the end frame 13 or mullion 14, the waste heat generated by the lamp 18 contained therein would escape to the interior of the refrigerated space. The waste heat would therefore increase the heat load on the refrigerated space and wastefully increase the energy needed to maintain the refrigerated space at the desired constant cool temperature.

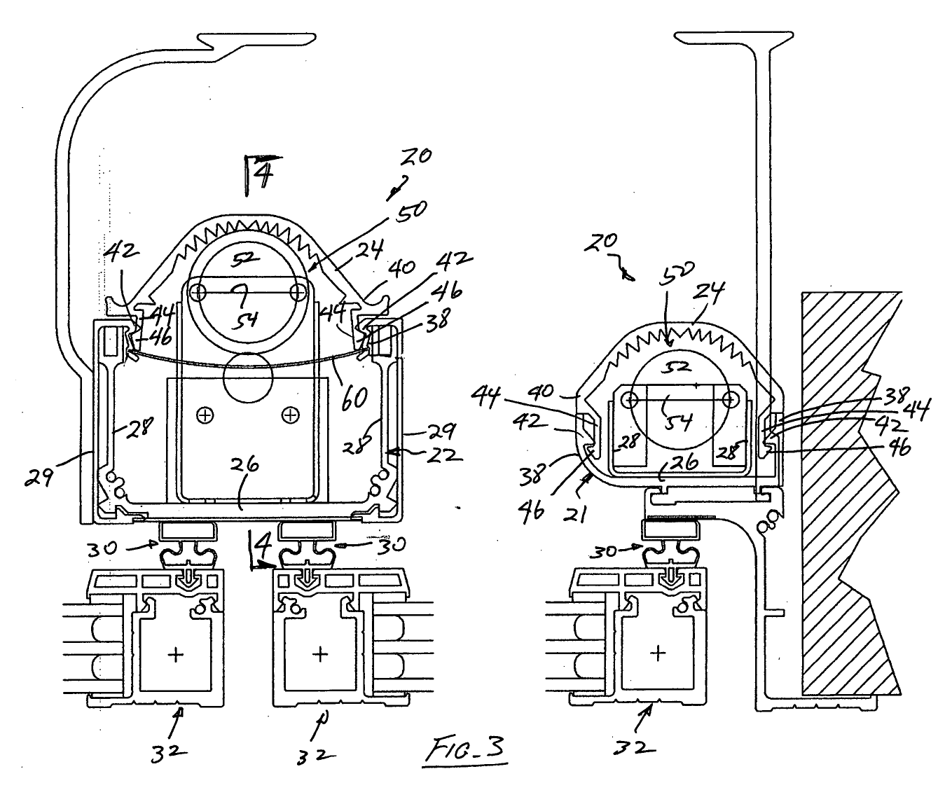

Referring now to FIG. 3, the integrated mullion and fluorescent lamp assembly 20 of the invention is integrated into the end frame 21 and/or mullion 22 by reconfiguring the end frame 21 and mullion 22 to each be open-ended along its rear side to removably accept a longitudinal lens 24. More particularly, the integrated mullion and fluorescent lamp assembly 20 comprises the end frame 21 and mullion 22 having an integral front wall 26, and opposing side walls 28, preferably parallel to each other. The front wall 26 is configured to provide a seal with the door seal 30 when the door 32 is closed. The side walls 28 are configured with appropriate grooves or the like to allow cosmetic flashing strips 29, preferably of a non-thermally conductive material such as plastic, to be mounted thereon that insulate the surfaces of the end frame 21 and mullion 22. The front wall 26 combined with the side walls 28 are appropriately configured to form part of the door frame 34 of the display refrigerator 36.

The leading longitudinal edges 38 of the side walls 28 of the end frame 21 and mullion 22 (or of the flashing strip 29) and the corresponding longitudinal edges 40 of the lens 24 are complementarily configured to be removably snapped together. While many configurations may exist, as shown in FIG. 3, one configuration comprises forming a longitudinal undercut 42 along the leading edges 38 of the side walls 28 or flashing strip 29. Complementarily, longitudinal tabs 44 with a hook 46 are provided along the longitudinal edge 40 of the lens 24. The opposing tabs 44 and hooks 46 of the lens 24 are dimensioned relative to the longitudinal undercuts 42 of the side walls 28 of the end frame 21 and mullion 22 such that the lens 24 may be aligned and then push inwardly to snap into place with the hooks 46 engaging underneath the respective undercuts 42, thereby removably securing the lens 24 about the rear opening across the side walls 28 of the end frame 21 and mullion 22 and defining a closed interior within the end frame 21 and mullion 22.

Positioned between the opposing side walls 28 of the end frame 21 and mullion 22 is a lamp assembly 50 comprising one or more fluorescent tubular lamps 52 operatively mechanically and electrically connected between respective lampposts 54. Preferably, if two or more shorted fluorescent lamps 52 are employed in lieu of a longer lamp 52, they are installed collinearly. Multiple long lamps 52 may alternatively or in combination be employed with a short lamp if desired in which case they may be positioned parallel to each other. Also, the interior cavity defined by the front and side walls 26 & 28 may be dimensioned to accommodate different-diameter fluorescent lamps 52. In each case, the heat produced by the lamp(s) 52 is substantially contained with the end frame 21 and mullion 22 by virtue of the closed system created by the lens 24, and is therefore absorbed by the front and side walls 26 & 28 thereof to heat the same and reduce or prevent condensation that might otherwise occur. Furthermore, the closed system serves to stabilize the temperature of the lamp(s) 52 and therefore maximize their light efficiency. Finally, the fact that the lens 24 protects the lamp(s) 52 minimizes lamp breakage should a product pulled from the shelving be inadvertently knocked against the end frame 21 or mullion 22.

The lens 24 preferably comprises a prismatic transparent or translucent lens of the type disclosed in U.S. Pat. No. 6,179,443 to direct the light emitted from the lamp(s) 52 onto the front of the shelving supported by the shelving supports 16.

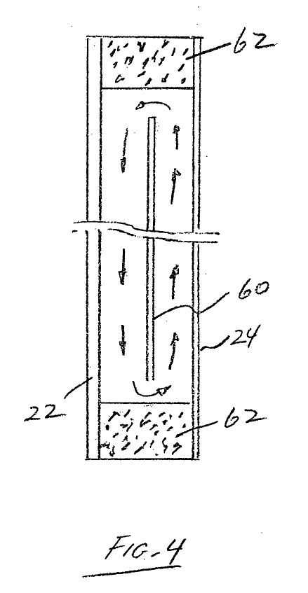

As shown in FIG. 3, a longitudinal reflector 60 may optionally be installed between the side walls 28 to reflect light from the lamp 52 outwardly toward the shelving 16. Preferably, the longitudinal reflector 60 is installed by snapping it into place between appropriate longitudinal grooves found in the snap-on flashing strips 29 to maintain the arcuate shape of the reflector 60. As shown in FIG. 4, the reflector 60 may be shortened to not extend fully from top to bottom. Foam plugs 62 may be installed between the lens 24 and the mullion 22 to block air flow. As a result, a chimney effect is created with heat from the lamp 52 flowing upwardly to then pass between the upper foam plug 62 and the reflector 60 and then into mullion 22, to then flow downwardly along the mullion to flow underneath the lower plug 62 to return to the lamp 52, thereby creating a circulatory flow of air to increase the warming of the mullion 22.

As used in the claims, the term “mullion” shall mean an end frame and/or a center frame between two doors.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. An integrated mullion and fluorescent lamp assembly for:
a display refrigerator, comprising in combination:
a mullion including an open-ended rear side;
a longitudinal lens removably positioned over said open-ended rear side of the mullion; and
a lamp assembly positioned within said mullion,
whereby heat from the lamp assembly heats the mullion.

2. The integrated mullion and fluorescent lamp assembly as set forth in claim 1, wherein said mullion includes an integral front wall and opposing side walls.

3. The integrated mullion and fluorescent lamp assembly as set forth in claim 2, wherein said side walls are substantially parallel to each other.

4. The integrated mullion and fluorescent lamp assembly as set forth in claim 1, wherein said front wall is configured to provide a seal with the door seal when the door is closed.

5. The integrated mullion and fluorescent lamp assembly as set forth in claim 1, wherein said side walls are configured with grooves to allow flashing strips to be mounted thereon.

6. The integrated mullion and fluorescent lamp assembly as set forth in claim 2, wherein said front wall and said side walls are configured to form part of the door frame of the display refrigerator.

7. The integrated mullion and fluorescent lamp assembly as set forth in claim 2, further including a longitudinal reflector to direct light assembly.

8. The integrated mullion and fluorescent lamp assembly as set forth in claim 2, wherein leading longitudinal edges of said side walls of the mullion and corresponding longitudinal edges of said lens are complementarily configured to be removably snapped together.

9. The integrated mullion and fluorescent lamp assembly as set forth in claim 8, wherein said leading edges of said side walls of said mullion comprise a longitudinal undercut and wherein said longitudinal edge of said lens comprises longitudinal tabs with a hook dimensioned relative to said longitudinal undercuts of said side walls of said mullion such that said lens may be aligned and then push inwardly to snap into place with said hooks engaging underneath respective said undercuts to removably secure said lens about said opened end of said mullion across said side walls of said mullion and defining a closed interior within said mullion.

10. The integrated mullion and fluorescent lamp assembly as set forth in claim 1, wherein said lamp assembly comprises a least one fluorescent tubular lamp operatively mechanically and electrically connected between respective lampposts.
